(19) United States
(12) Patent Application Publication
(10) Pub. No.: US 2025/0326135 A1
(43) Pub. Date: Oct. 23, 2025

(54) EXTENSIBLE ROBOTIC SYSTEM

(71) Applicant: Dexterity, Inc., Redwood City, CA (US)

(72) Inventors: Samir Menon, Atherton, CA (US); Zhouwen Sun, San Mateo, CA (US); Keshav Prasad, Saratoga, CA (US); Robert Holmberg, Mountain View, CA (US); Gil Matzliach, Sunnyvale, CA (US); Prabhat Kumar Sinha, Santa Clara, CA (US); Rohun Kulkarni, Palo Alto, CA (US)

(21) Appl. No.: 19/182,466

(22) Filed: Apr. 17, 2025

Related U.S. Application Data
(60) Provisional application No. 63/636,579, filed on Apr. 19, 2024.

(51) Int. Cl. B25J 13/00

(52) U.S. Cl. CPC B25J 13/006

(57) ABSTRACT

An extensible robotic system is disclosed. In various embodiments, the system includes a plurality of robotically controlled elements and a processor coupled to a robotically controlled element included in the plurality of robotically controlled elements and configured to control operation of the robotically controlled element to which it is coupled via communications sent via a standard interface implemented across said plurality of robotically controlled elements and to communicate with the robotic system via a communication interface using a communication protocol associated with the robotic system.

### CROSS REFERENCE TO OTHER APPLICATIONS

This application claims priority to U.S. Provisional Patent Application No. 63/636,579 entitled EXTENSIBLE ROBOTIC SYSTEM filed Apr. 19, 2024 which is incorporated herein by reference for all purposes.

### BACKGROUND OF THE INVENTION

A modern robotic system and operation typically involves a variety of hardware and software components, which are used in concert to operate one or more robots to perform tasks to achieve an operational objective.

For example, in a warehouse or other logistics context, one or more robots may be used to load/unload trucks or other containers, stack items on a pallet or remove them from a pallet, assemble dissimilar items into boxes or bins, retrieve items from and/or place them on a shelf or other receptacle, perform singulation/sortation, etc.

To perform such tasks, robotic arms equipped with a variety of grippers; autonomous mobile robots, automated guided robots, etc., and other robots may be used in cooperation to move materials between work locations; and/or other robots may be used in connection with cameras, sensors, safety equipment and subsystems, lighting systems, material handling equipment, etc.

In current approaches, integration of such systems is a costly, time-consuming process mostly driven by highly skilled human workers.

### BRIEF DESCRIPTION OF THE DRAWINGS

Various embodiments of the invention are disclosed in the following detailed description and the accompanying drawings.

FIG. 1A is a diagram illustrating an embodiment of an extensible robotic system.

FIG. 1B is a diagram illustrating an embodiment of an extensible robotic system.

FIG. 2 is a block diagram illustrating an embodiment of an extensible robotic system.

FIG. 3 is a flow diagram illustrating an embodiment of a process to incorporate a new element into an extensible robotic system.

FIG. 4 is a flow diagram illustrating an embodiment of a process to communicate securely with a new element comprising an extensible robotic system.

FIG. 5 is a diagram illustrating an embodiment of a USB-C type adapter to retrofit an element to participate in an extensible robotic system.

FIG. 6 is a diagram illustrating an embodiment of a printed circuit board (PCB) adapter to retrofit an element to participate in an extensible robotic system.

FIGS. 7A-7C illustrate an embodiment of a replacement plug type adapter to retrofit an element to participate in an extensible robotic system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An intelligent, highly capable, and adaptive robotic system comprising robots, auxiliary hardware, and software components that organize themselves to cooperate to perform a set of tasks to achieve a high-level objective is disclosed. In various embodiments, a “plug and play” capability is provided. New hardware and/or software may be added to a system. Upon initial connection, trust is established, capabilities (skills) and requirements are learned, and the new hardware and/or software is/are integrated into the system.

In various embodiments, the robotic system is controlled by an artificial intelligence powered computing platform. The computing platform provides access to and coordinates invocation and use of a set of skills of the robotic system. Examples of skills including, without limitation, how to pick, how to place, how to move, stack, manage fleets, have robots use one arm or two arms, suction grippers or grabbing grippers, etc. For different robotics applications, the respective skill sets may overlap, but each set may include skills specific to the application. For example, a robotic system used to perform singulation/sortation must be able to pick and place items, and those skills also would be required to stack items on a pallet or in a truck, etc.

In various embodiments, a robotics computing platform as disclosed herein may include and/or use a variety of ancillary modules required for the skills to work. Examples of such modules include computer vision, motion planning, collision avoidance, simulation, etc. The computing platform may be used in connection with a decision engine comprising software configured to invoke skills made available via the computing platform, in specific ways and in a determined sequence and timing, to cause robotic elements, such as a robotic arm and gripper, to be used to perform tasks in a sequence and manner that achieves an objective, such as to unload items from a truck, or stack items on a pallet, etc. In some cases, the decision engine may be integrated into the computer platform.

One or more robotics applications may be run on top of the decision engine and/or the computing platform. A robotics application may comprise code associated with the performance of a specific type of operation, such as palletization/depalletization, truck/container loading/unloading, sortation/singulation, shelf kitting, line kitting, etc. A single application may comprise code to implement a variety of robotics applications (use cases), or separate applications may be defined for each robotics application (use case), e.g., one for singulation, one or palletization/depalletization, etc.

In some embodiments, an application framework, runtime, software development kit (SDK), application programming interface (API), etc., may be provided, to enable a third-party developer to develop an application to run on the decision engine and/or computing platform. The application may invoke and use previously-defined skills and/or the third-party developer may define and use new skills, e.g., skills that invoke and combine lower-level primitives exposed by the computing platform to cause the robotic arm or other robotic instrumentality to exhibit a desired behavior (skill).

In some embodiments, one or more of the application(s), decision engine, and computing platform may be integrated into a single entity and/or implemented on a system physical system, such as a computer, a microcontroller or other chip or board, a robotics controller associated with a robotics hardware platform, etc.

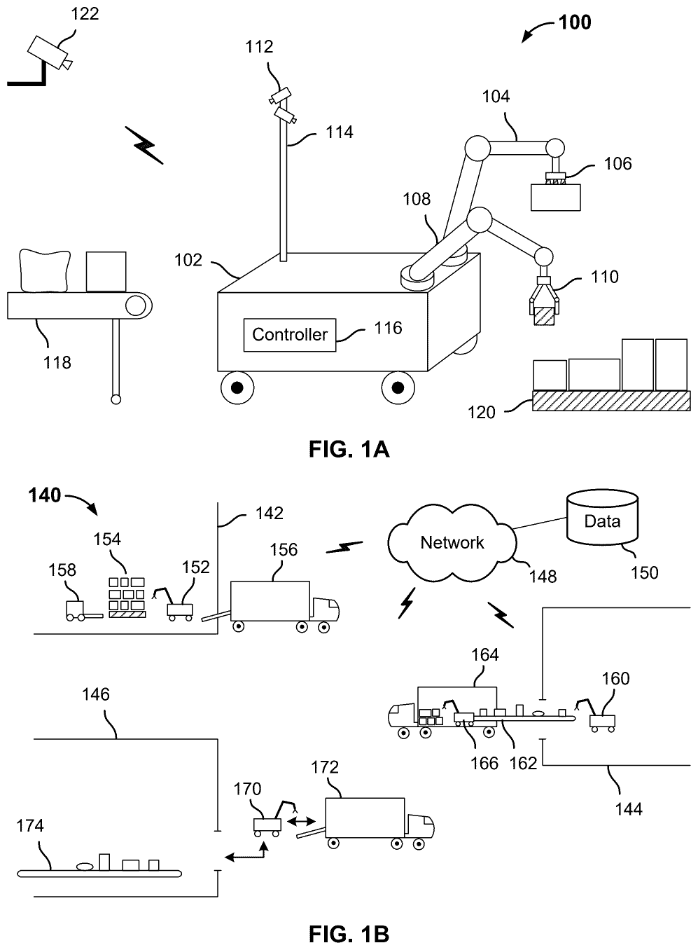

FIG. 1A is a diagram illustrating an embodiment of an extensible robotic system. In the example shown, system 100 includes a mobile base 102 on which robotic arm 104 with suction type end effector 106 and robotic arm 108 with gripper style end effector 110 are mounted. Cameras 112 are mounted on mobile base 102 via a pole or other superstructure 114.

The system 100 is shown in FIG. 1A to be engaged in palletization or depalletization, e.g., picking items from conveyor 118 and stacking them on pallet 120 or vice versa.

In the example shown, mobile base 102 includes a controller 116 configured to operate mobile base 102 autonomously or semi-autonomously, e.g., to navigate from a start location into the work location as shown. Controller 116 may be configured to control the robotic arms 104, 108 and/or end effectors 106, 110, directly or indirectly. For example, controller 116 may control the robotic arms 104, 108 directly, e.g., by sending torque commands to motor controllers for the respective joints comprising the robotic arms 104, 108 or indirectly, e.g., by sending commands to robotic arm controllers comprising the robotic arms 104, 108.

In various embodiments, controller 116 may be configured to perform a robotic application, such as palletization/depalletization, such as by invoking or installing a robotic application that runs on a framework or environment supported and/or provided on controller 116. Controller 116 may be commanded, configured, etc. to perform the application via wireless communications, e.g., from a central and/or peer node with which controller 116 is configured to communicate, e.g., via local wireless communications, network communications, etc.

In various embodiments, controller 116 may be configured to communicate with other elements comprising the system 100, e.g., robotic arms 104, 108 according to a proprietary, standards-based, negotiated, and/or otherwise determined protocol. Controller 116 may be configured to operate the wheels of mobile base 102; robotic arms 104, 108; and/or end effectors 106, 110 synchronously to pick items from conveyor 118 and stack them on pallet 120, for example.

In the example shown, system 100 includes a camera 122 installed in the workspace. Controller 116 may be configured to control one or more of the onboard cameras 112 and camera 122 as needed to perform the robotic palletization/depalletization task it has been assigned. For example, controller 116 may control the frame rate, resolution, optical focus, pan/tilt, and/or other aspects of the operation of the cameras 112, 122 as/if need to (better) perform its assigned work. For example, one or more cameras may be turned off when not needed, to conserve electricity and/or battery life. A camera may be switched to a higher frame rate, narrower field of view, etc., such as to enable the system to “concentrate” more closely on a fine or difficult task, such as pushing an item into place or navigating through a tough space.

In some embodiments, controller 116 and/or another controller comprising the system 100 may be configured to control operation of conveyor 118, e.g., to change the speed as required or supported by the pick/place throughput of the system.

In various embodiments, controller 116 may be configured to track and report to a remote node usage statistics for one or more of the elements comprising system 100, such as robotic arms 104, 108 and/or end effectors 106, 110. The usage data may be tracked to plan maintenance, predict failures, schedule repair or replacement, etc.

FIG. 1B is a diagram illustrating an embodiment of an extensible robotic system. In the example shown system 140 is distributed across multiple sites comprising a wide area, including in this example warehouse and/or distribution center sites 142, 144, and 146. At each site, robotic and auxiliary equipment (cameras, sensors, material handling, safety systems and components, etc.) comprising an integrated robotics system, distributed over a wide area, operate autonomously and/or semi-autonomously to perform tasks associated with one or more robotic applications to accomplish a high level objective, such as to load or unload a truck; remove items from a pallet or stack them on a pallet; move items within a site to a shelf or other storage location; place items in or on a shelf or other storage location; retrieve items from a shelf or other storage location; place items in boxes or other containers for shipment; etc.

In the example shown in FIG. 1B, elements comprising system 140 communicate with each other and/or with other nodes, not shown in FIG. 1B, via network 148. Database 150 maybe used to store robotic applications; logistical information (e.g., where elements are located); configuration information (e.g., which elements are positioned at which sites, what are their respective capabilities, etc.); and operational information (e.g., invoices, manifests, or other information as to which items or sets of items are located where, to which destination is each item bound, etc.).

In some embodiments, database 150 may store a repository of learned information, such as skills learned by one or more elements at a first site which are then communicated via network 148, stored in database 150, and later communicated via network 148 to one or more other elements comprising system 140. In this way, lessons learned at one site or by one element of the system 140 may be shared with other elements and later used to perform similar tasks.

In the example shown in FIG. 1B, site 142 includes a mobile logistics robot 152, e.g., similar to the robot 102, 104, 106, 108, 110 of FIG. 1A, configured to take items from pallet 154 and load them into truck 156. In this example, a robotic forklift 158 (e.g., an autonomous guided vehicle or AGV) is shown to have placed the pallet 154 in position. The elements shown and/or other elements comprising system 140 may have tasked the elements at site 142 to load the items into truck 156.

At site 144, mobile logistics robot 160 is shown to be picking items from a conveyor 162 that is extended into truck 164. A second mobile logistics robot 166 is shown to have entered the truck 164 to unload the truck 164 by picking items from the truck and placing them one by one onto conveyor 162. In various embodiments, one or more elements comprising system 140 at site 144 may control the conveyor 162, e.g., to position the conveyor 162 in truck 164, move it further into truck 164 as it is unloaded, control the direction and speed of conveyor 162 according to throughput, etc.

At site 146, mobile logistics robot 170 is shown to be shuttling items between truck 172 and conveyor 174 in the warehouse or distribution center of site 146, e.g., to load or unload truck 172.

At all sites 142, 144, 146, elements comprising system 140 may be configured to report their respective location, status, workload, availability, usage statistics, etc., e.g. via network 148 for storage in database 150.

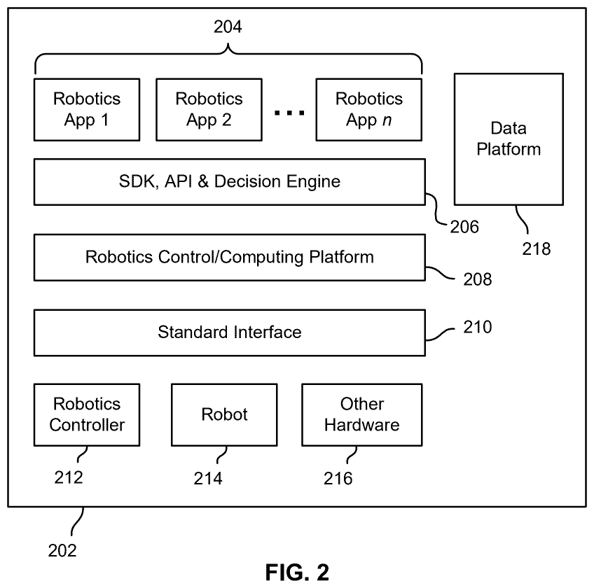

FIG. 2 is a block diagram illustrating an embodiment of an extensible robotic system. In the example shown, controller 202 embodies a software stack/architecture used in various embodiments to provide an extensible robotic system, as disclosed herein. As shown, controller 202 includes a plurality of robotics applications 204 (e.g., truck load/unload, palletization/depalletization, kitting, singulation, sortation, etc.) running via a software development kit (SDK), application programming interface (API), and/or Decision Engine 206 on a robotics control/computing platform 208. Commands to cause robotically controlled elements are communicated via standard interface 210 to one or more robotics controllers 212 (e.g., controller 116 of FIG. 1A), robots 214, and/or other hardware 216 (e.g., cameras, material handling equipment, etc.)

In various embodiments, the robotics controller in FIG. 2 may control a robotic platform and/or other robotic elements, such as one or more robotic arms, and/or other elements, such as material handling equipment or other auxiliary equipment, cameras and other sensors, safety system components, etc.

In various embodiments, the computing platform and/or layers above it may communicate with any compatible hardware or software component, such as a compatible robot or robotics platform, via a standard interface, such as standard interface 210. The standard interface may be a private or public (e.g., API, published, and/or open interface), which defines a communication protocol, syntax, grammar, etc. to enable standard-compliant computing platforms and/or robotics system components (robots, other actuators, cameras, other sensors, material handling equipment and/or other auxiliary equipment, etc.) to communicate about needs, conditions, context, resources, skills, requirements, etc.

Referring further to FIG. 2, in the example shown one or more robotics applications 204, platform 208, robotics controller(s) 212, robot(s) 214, and other hardware 216 may communicate information such as equipment status, usage statistics, etc. via data platform 218 and/or may obtain data via data platform 218, such as configuration data, strategies learned by other elements to perform certain tasks, etc.

In various embodiments, the modules/layers shown in FIG. 2 comprise an extensible systemwide architecture, many instances of which may exist, each associated with a set of one or more elements comprising an extensible robotic system as disclosed here.

In various embodiments, elements comprising a system as disclosed herein may be added or removed dynamically (e.g., plug and play). Techniques disclosed herein may be used to maintain trust/security, establish and maintain communications/connectivity, learn and use capabilities (skills), etc.

In various embodiments, a new element (hardware, software, combination of hardware and software) may be added to a robotics system, the elements of which may be local or distributed over a wide area, such as the robotics system elements of a large enterprise having operations at multiple physical locations.

A new element is connected and announces itself via a standard protocol. One or more elements comprising the system may allow a connection to determine if trust can be established. Trust may be based on one or more of a configured credential, such as a cryptographically signed certificate, a shared secret, a vendor or equipment identifier, etc. Once trusted, the capabilities (skills), context (e.g., geographic location), and requirements of the new element may be determined. For example, standards-based codes or other shorthand may be used to communicate a new element's capabilities, context, and requirements to other elements comprising the system. Once connected and understood, a newly added element may be included in decision-making and operation of the system.

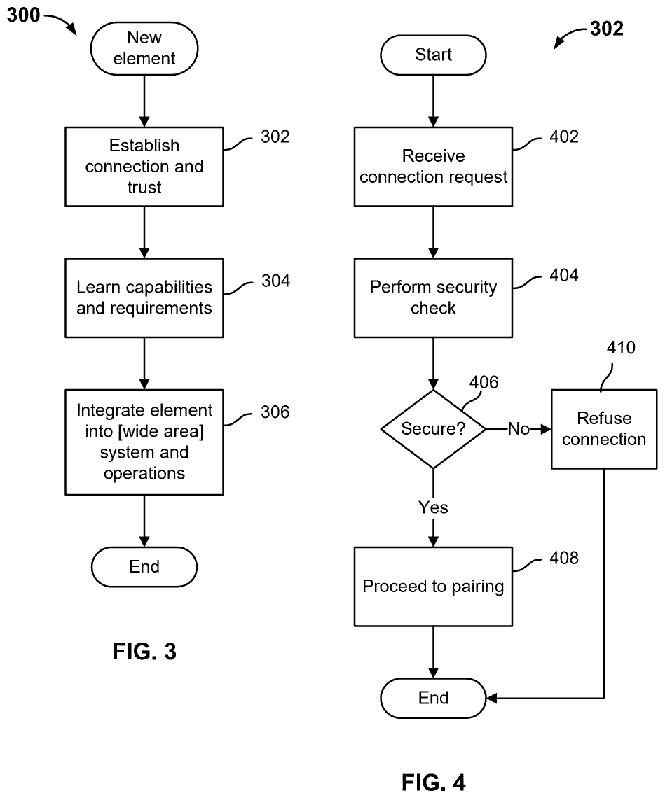

FIG. 3 is a flow diagram illustrating an embodiment of a process to incorporate a new element into an extensible robotic system. In various embodiments, the process 300 of FIG. 3 may be implemented by a central or local robotic control node, such as a server, control computer, or integrated controller. In the example shown, at 302, a communications channel is established and trust is verified. For example, a standards-based or proprietary communication protocol may be used to establish a connection. A security protocol may be followed to establish trust. At 304, the capabilities and requirements of the new element are determined. Examples include, without limitation, the nature of the element (robotic base, robotic arm, other robot, material handling equipment, etc.), the payload or other work capacity of the element (e.g., max weight, speed, etc.), and services required by the element to operate (e.g., battery charge level, electrical power supply, pneumatic air supply, e.g., to generate vacuum for a suction-type end effector, etc.). At 306, the element is integrated into a (potentially wide area) robotic system and its operations. For example, the presence, identify, location, nature, capabilities, and requirements of the element may be made known to other elements located at the same site and integrated, e.g., by a scheduler or other planner module, into the work to be performed at the site.

FIG. 4 is a flow diagram illustrating an embodiment of a process to communicate securely with a new element comprising an extensible robotic system. In some embodiments, the process of FIG. 4 is used to implement step 302 of the process 300 of FIG. 3. In the example shown, at 402 a request to connect is received. At 404, a security check is performed. For example, the new element may be authenticated, may undergo or be required to perform a virus check and/or self-diagnostic tests, etc. If the new element is determined at 406 to be secure, then at 408 processing to incorporate the new element into the system proceeds. For example, if performed locally step 408 may include pairing or otherwise establishing a persistent communication and/or interworking relationship with one or more other local elements, such as controller 116 pairing with a newly installed robotic arm or end effector. If at 406 the new element is determined not to be secure, then at 410 the connection is refused and human intervention or other remediation may be required.

In various embodiments, granular, localized control of peripheral systems and devices may be provided. For example, a computing platform and/or robot controller may be able to toggle a camera or other sensor off and on, or increase or decrease a rate of operation, such as a frame or sampling rate. A robotic system may “see” a danger approaching, such as an approaching human or other robotic worker, and may direct greater system attention to the source of risk or danger, just as a human worker would conduct themselves with greater awareness as another worker approached them while they were performing a task that could cause harm to the other worker or themselves, damage to material or equipment, etc.

In various embodiments, legacy equipment may be integrated into an advanced robotics system by designing and/or providing a hardware and/or software adapter. For example, a dongle or other hardware adapter may provide the physical interface to connect to the equipment and implement a standard protocol to communicate and be controlled by other elements comprising the robotic system.

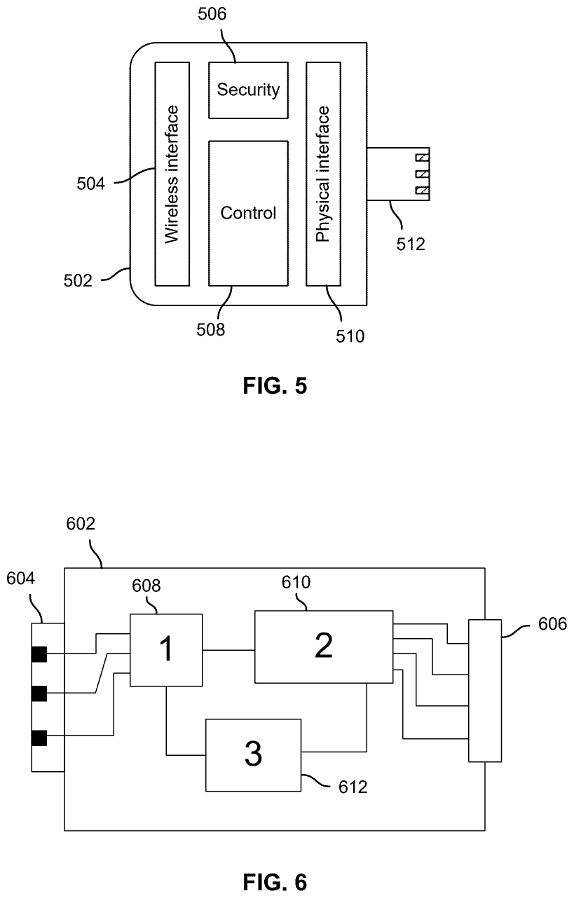

FIG. 5 is a diagram illustrating an embodiment of a USB-C type adapter to retrofit an element to participate in an extensible robotic system. In various embodiments, an adapter such as adapter 502 of FIG. 5 may be used to integrate legacy equipment into an extensible robotic system as disclosed herein. In the example shown, adapter 502 includes a wireless interface 504, configured to provide communication with other elements comprising the robotic system; a security module 506 configured to authenticate to robotics system and/or elements comprising the robotics system an equipment into which the adapter 502 has been installed, e.g., by performing the process 302 of FIG. 4; control module 508 configured to control the equipment into which the adapter 502 has been installed, e.g., by implementing an instance of the architecture shown in FIG. 2; and a physical interface 510 configured to control the equipment, e.g., via commands sent and communications received via USB-C (or other) connector 512.

In various embodiments, adapter 502 may be installed in an equipment by inserting connector 512 into a USB-C port of the equipment. Upon being installed, the adapter 502 is powered via the USB-C connector 512, wakes up, initializes, and establishes communication with the extensible robotics system via wireless interface 504 and with the equipment via control module 508 and physical interface 512.

FIG. 6 is a diagram illustrating an embodiment of a printed circuit board (PCB) adapter to retrofit an element to participate in an extensible robotic system. In the example shown, adapter 602 comprises a PCB that may be installed by disconnecting a printed circuit board comprising the equipment, such as a controller or other board, inserting the male connector 604 into the female socket of the equipment and inserting the male connector of the native board that was removed from the female socket of the equipment into female socket (receiver) 606 of adapter 602. In the example shown, adapter 602 includes functional modules 608, 610, 612 interconnected with each other and with male connector 602 and female socket 606, as shown, via traces on the PCB comprising adapter 602.

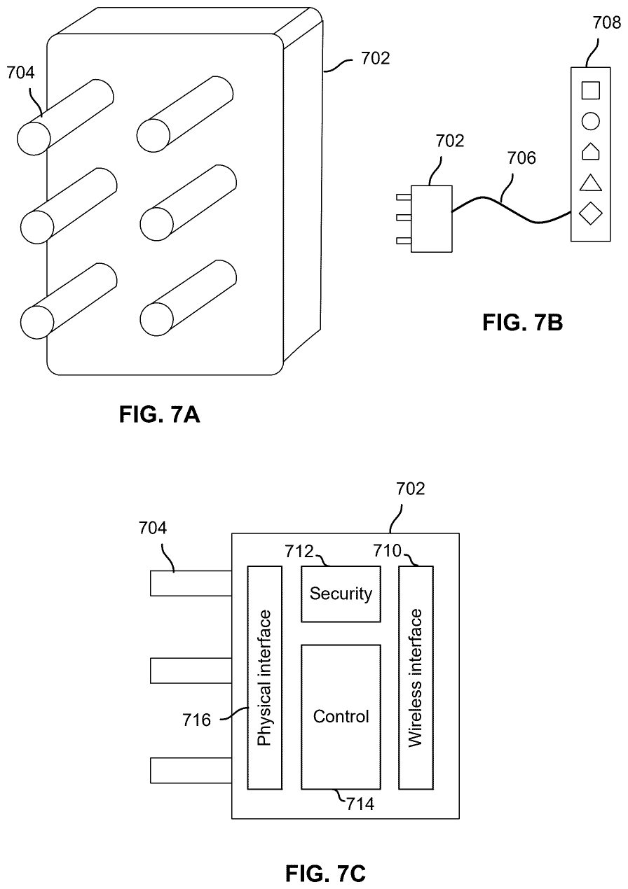

FIGS. 7A-7C illustrate an embodiment of a replacement plug type adapter to retrofit an element to participate in an extensible robotic system. Referring first to FIG. 7A, in the example shown, replacement connector 702 includes six pins 704 having a number, positions, dimensions, etc. corresponding to pins of a connector comprising a robot or auxiliary equipment in a workspace, such as an extendable conveyor or other material handling equipment. In various embodiments, the adapter 702, when installed in place of and/or in line with a manual controller or other peripheral equipment, facilitates communication and control of the material handling or other equipment.

FIG. 7B shows a hand-operated controller 708 connected by cable 706 to adapter 702. The adapter 702 provides the same plug-in interface as the original manual controller, which it replaces, and includes internal elements to communicate with a robotic system controller or other elements comprising an integrated robotics system as disclosed herein, as shown in FIG. 7C. Specifically, FIG. 7C shows the adapter 702 to include the same functional elements as adapter 502 of FIG. 5, i.e., a wireless interface 710, security module 712, control module 714, and physical interface 716.

In various embodiments, elements comprising a robotics system as disclosed herein may be configured to report data to one or more other elements. For example, all components may provide reports of their own health, operational state, and/or operational data (e.g., use statistics, errors, measurements or other sensor readings, events, etc.) to a computing platform comprising the system (e.g., via the data platform 218 of FIG. 2). Reports may indicate a problem requiring human intervention and optionally an indication of what must be done to restore the equipment to its full operational capability.

In some embodiments, an inventory of elements comprising the system and for each element its relevant information may be maintained, such as manufacture, make, and model; robot class; capability code(s); product ID; adapter code and version; a unique ID; mileage, odometer, or other life cycle measurements; date of manufacture; and/or other data or metadata.

Other metadata may include robot kinematics (e.g., a model and/or description of the joints and links comprising the robot, the kinematics of each joint, etc.); communications (physical interface(s), latency, throughput, protocols; mechanical (weight, lifetime); and robot design parameters (performance, accuracy/repeatability, compliance, rated payload).

In various embodiments, processing/control may be distributed (or otherwise done cooperatively) across multiple processors, equipment, and/or nodes. Peer-to-peer control and communication protocols may be implemented, e.g., to enable two or more elements to work out between them which element will do (or control) what. Various techniques may be used to avoid or resolve conflicts, such as competing attempts to invoke a resource, e.g., locking or token-based schemes, a hierarchy-or priority-based approach, or a negotiation protocol.

In various embodiments, elements comprising a robotic system may be classified as an actor, which participates actively in decision making and control, or an observer, which participates more passively in operations but may be a critical resource used by other elements, e.g., actors. Each (actor or observer) may be stateful or not. As elements are integrated into a robotic system as disclosed herein, they are integrated with an awareness of whether they are an actor, or an observer, or both, and whether they are stateful or stateless.

Examples of stateful actors: Pairing, requires authentication; force sensor that has calibration metrics, which is a function of gripper type; and verification of type of tool (e.g., palm)-ensure the right tool type is attached.

Examples of stateless actors: safety system with simple on/off switch.

Examples of stateful observers: Zone-based safety system-has memory based on how zones were activated, for example by or associated with a large versus smaller robot; camera that takes an image based on recognition or what it has seen before, or uses audio-based input to take pictures at a specific time.

Examples of stateless observers include: simple camera, with extensible system-compatible chip or adapter, for example.

In various embodiments, techniques disclosed herein may be used to provide and operate an extensible robotic system. Elements may be added or removed dynamically. Usage may be monitored, controlled, and tracks, over a wide area incorporating multiple operating sites.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic system, comprising:
a plurality of robotically controlled elements;
a processor coupled to a robotically controlled element included in the plurality of robotically controlled elements and configured to control operation of the robotically controlled element to which it is coupled via communications sent via a standard interface implemented across said plurality of robotically controlled elements and to communicate with the robotic system via a communication interface using a communication protocol associated with the robotic system.

2. The robotic system of claim 1, wherein the robotically controlled element coupled to the processor comprises a robotic arm.

3. The robotic system of claim 2, wherein the processor is configured to control operation of the robotic arm directly.

4. The robotic system of claim 2, wherein the processor is configured to control operation of the robotic arm indirectly via a robotic controller associated with the robotic arm.

5. The robotic system of claim 1, wherein the robotically controlled element coupled to the processor comprises an auxiliary equipment.

6. The robotic system of claim 5, wherein the auxiliary equipment comprises a camera or other sensor.

7. The robotic system of claim 5, wherein the auxiliary equipment comprises a material handling equipment.

8. The robotic system of claim 1, further comprising the communication interface.

9. The robotic system of claim 8, wherein the communication interface comprises an adapter.

10. The robotic system of claim 9, wherein the communication interface comprises a wireless interface comprising the adapter.

11. The robotic system of claim 9, wherein the processor controls the auxiliary equipment via signals sent via a physical interface comprising the adapter.

12. The robotic system of claim 1, wherein the processor is further configured to integrate a new element into the robotic system.

13. The robotic system of claim 12, wherein integrating the new element includes one or more of establishing a connection, establishing trust, learning one or more capabilities of the new element, learning one or more requirements of the new element, and providing information about the new element to one or more elements comprising the robotic system.

14. The robotic system of claim 1, wherein the plurality of robotically controlled elements are distributed over multiple sites comprising a wide area.

15. The robotic system of claim 1, wherein the processor is configured to communicate to the robotic system usage data associated with the robotically controlled element coupled to the processor.

16. The robotic system of claim 15, wherein the usage data comprises a strategy learned in connection with use of the robotically controlled element coupled to the processor to perform a task.

17. The robotic system of claim 16, wherein the processor is further configured to receive via the communication interface and use in connection with control of the robotically controlled element coupled to the processor a strategy learned in connection with another element comprising the robotic system.

18. The robotic system of claim 1, wherein the processor comprises a first processor and the robotically controlled element coupled to the first processor comprises a first robotically controlled element; and wherein each of at least a subset of the plurality of robotically controlled elements other than the first robotically controlled element is associated with a corresponding processor configured to control the element via the standard interface implemented across said plurality of robotically controlled elements.

19. A method to control a robotic system comprising a plurality of robotically controlled elements, comprising:
controlling operation of the robotically controlled elements via communications sent via a standard interface implemented across said plurality of robotically controlled elements, each being controlled by a corresponding processor configured to implement the standard protocol; and
coordinating operation of the robotically controlled elements via communications sent to the respective processors via a communication interface using a communication protocol associated with the robotic system.

20. A computer program product to control a robotic system comprising a plurality of robotically controlled elements, the computer program product being embodied in a non-transitory computer readable medium and comprising computer instructions for:
controlling operation of the robotically controlled elements via communications sent via a standard interface implemented across said plurality of robotically controlled elements, each being controlled by a corresponding processor configured to implement the standard protocol; and
coordinating operation of the robotically controlled elements via communications sent to the respective processors via a communication interface using a communication protocol associated with the robotic system.
